(19) United States
(12) Patent Application Publication
(10) Pub. No.: US 2025/0102626 A1
(43) Pub. Date: Mar. 27, 2025

(54) METHOD OF DETECTING GHOST OBJECTS IN SENSOR MEASUREMENTS

(71) Applicant: MERCEDES-BENZ GROUP AG, Stuttgart (DE)

(72) Inventors: Thomas MONNINGER, Menlo Park, CA (US); Julian SCHMIDT, Steißlingen (DE); Jan RUPPRECHT, Herrenberg (DE); David RABA, Augsburg (DE); Tobias WELZ, Stuttgart (DE)

(21) Appl. No.: 18/833,518

(22) PCT Filed: Dec. 12, 2022
(86) PCT No.: PCT/EP2022/085336

§ 371 Date: Jul. 26, 2024

(30) Foreign Application Priority Data
Jan. 28, 2022 (DE) 10 2022 000 331.7

(51) Int. Cl. G01S 7/41; G01S 13/86; G01S 13/931

(52) U.S. Cl. CPC G01S 7/417; G01S 13/865; G01S 13/867; G01S 13/931

(57) ABSTRACT

A method of detecting ghost objects in sensor measurements of an environment of a vehicle involves obtaining map context information from a digital road map. Objects having associated attributes are recognized in an environment of the vehicle, and social context information of the objects in relation to one another is generated. All available data of a traffic situation with the vehicle and the objects is stored in a graph structure, having nodes and edges. Relational information is depicted in the graph structure by the edges. Anomalies and patterns are searched for in features of the graph structure while taking the map context information and the social context information into account, whereby ghost objects are classified using recognized anomalies and patterns.

### BACKGROUND AND SUMMARY OF THE INVENTION

Exemplary embodiments of the invention relate to a method of detecting ghost objects in sensor measurements of an environment of a vehicle.

A method for a radar system of a vehicle is known from DE 10 2020 124 236 A1, the method having the following steps:
detecting two or more objects using the radar system of the vehicle;
initiating tracks of the two or more objects in a track database, wherein the tracks respectively store data for the two or more objects and are updated on the basis of additional detections of the two or more objects, and the tracks of the two or more objects are initially unclassified tracks in the track database;
selecting two tracks as a candidate pair using a processor, the tracks corresponding to two of the two or more objects from the track database;
applying criteria to the candidate pair using the processor to determine whether one track of the two tracks of the candidate pair is a track of a ghost object that results from a multipath reflection, and another track of the two tracks of the candidate pair is a track of a real object that corresponds to the ghost object, wherein the ghost object represents the recording of the real object in an incorrect location;
classifying the candidate pair in the track database as tracks of a real object and ghost object pair using the processor on the basis of the determination that one track of the two tracks of the candidate pair is the track of the ghost object and the other track of the two tracks of the candidate pair is the track of the real object that corresponds to the ghost object; and
reporting information from the track database, and on the basis of the classification, the reporting comprises providing the data only for the track of the real object, wherein the information is used to control an operation of the vehicle.

DE 10 2021 001 452 A1 describes a method for recording the environment by means of a radar, wherein objects located outside of a line of sight of the radar are detected. In this case, raw radar data recorded by means of the radar is pre-processed in a processing step and adapted for a subsequent processing step. In a subsequent processing step, radar reflections are determined in the pre-processed raw radar data by means of a classification algorithm. In a further subsequent processing step, the radar reflections are used to generate a topology of a radar environment and in a further subsequent processing step, radar detections in the topology of the radar environment are used to differentiate between directly visible objects and objects located outside of the line of sight of the radar.

Furthermore, DE 10 2021 005 084 A1 describes a method for identifying map attributes and map relationships of objects. In this case, dynamic information, static information, including geospatial distances between objects, semantic information and relational information is illustrated in a graph. Map attributes and map relationships are learnt from the graph using a graph neural network, wherein a map in which the map attributes and map relationships to be learnt have been manually labelled, or automatically generated geometric information, is used to train the graph neural network.

Exemplary embodiments of the invention are directed to a novel method for detecting ghost objects in sensor measurements of an environment of a vehicle.

In the method for detecting ghost objects in sensor measurements of an environment of a vehicle, according to the invention, map context information is obtained from a digital road map, objects having associated attributes are recognized in the environment of the vehicle and social context information of the objects in relation to one another is generated. All available data of a traffic situation with the vehicle and the objects is stored in a graph structure, comprising nodes and edges, wherein relational information is depicted in the graph structure by means of the edges. Anomalies and patterns are searched for in features of the graph structure while taking the map context information and the social context information into account, and ghost objects are classified using recognized anomalies and patterns.

For an automated, in particular highly automated or autonomous driving mode of vehicles, precise recognition of objects in the environment of the vehicle is necessary. In order to meet high safety requirements in automated driving modes, for example according to level 2, level 3, level 4 and level 5 of the standard SAE J3016, sensor measurements of sensor modalities, for example camera sensors, radar sensors and/or lidar sensors, are required. The sensor modalities in particular form a redundant sensor system having several similar and/or different sensor modalities. The sensor measurements of the sensor modalities are used individually or in combination.

For the greatest safety possible, a latency of a reaction of the vehicle to an object must be minimal. For this reason, a few sensor measurements or each individual sensor measurement can lead to a system reaction. In addition to true-positive measurements, the sensor measurements include false-positive measurements, in which an object has been detected at a location at which there is no object in reality. False-positive measurements can arise, for example, due to undesirable sensor reflections, erroneous detections, and/or detections of depictions of environment objects, for example a vehicle depicted on a billboard. A typical example is radar reflections from crash barriers or sign gantries.

An automated vehicle generates an object from such a false-positive measurement. Because this object is not present in reality, such an object is generally described as a ghost object. Reactions of the automated vehicle to ghost objects can lead to dangerous situations, for example to an emergency braking process with a resulting rear-end collision.

By means of the present method, ghost objects can be detected particularly effectively and reliably. Because the method uses information about all objects in the traffic situation or scene, it is possible to decide whether the attributes of an object indicate an anomaly in comparison with surrounding objects. Because the method uses context information for a comprehensive depiction of the scene, a context-based classification of objects can be implemented in which, for example, the road network on which it is based is used. By means of the method, it is also possible to take temporal aspects into account in order to extract patterns via the temporal dimension.

The method thus makes it possible to record the environment of the vehicle with a high degree of sensitivity and retroactively to detect ghost objects, i.e., false-positive measurements, and to remove them from the recording. A danger of real objects not being detected in the environment is thus reduced. This means that a probability of false-negative and false-positive measurements is significantly reduced.

An extension to a learning-based classification provided in a possible embodiment of the method makes it possible to extract complex patterns that cannot be defined manually. This also means that the method and a system carrying it out can be scaled with data.

Exemplary embodiments of the invention are explained in more detail in the following with reference to drawings.

### BRIEF DESCRIPTION OF THE DRAWING FIGURES

Here:

FIG. 1 schematically shows a plan view of a traffic situation,

FIG. 2 schematically shows a plan view of the traffic situation according to FIG. 1 with generated nodes for a graph structure,

FIG. 3 schematically shows the nodes according to FIG. 2, and edges connecting them for the graph structure,

FIG. 4 schematically shows a graph structure having several nodes and relationships between the nodes, and

FIG. 5 schematically shows a configuration of a graph structure and the processing of information present in the graph structure with a graph-based artificial neural network.

Parts corresponding to one another are provided with the same reference signs in all Figures.

### DETAILED DESCRIPTION

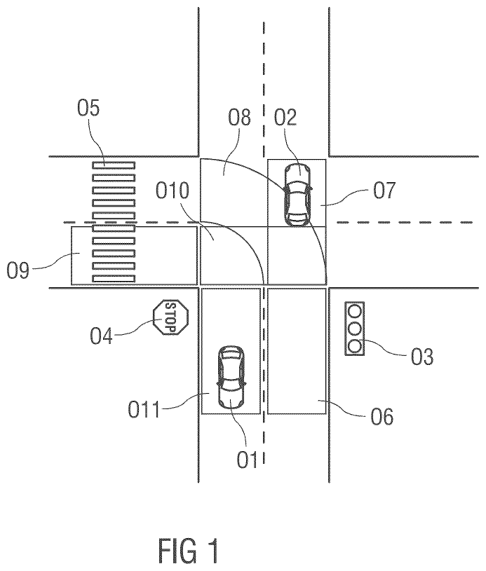

FIG. 1 shows a plan view of a traffic situation at a road crossing, with objects O6 to O11 in the form of lane segments originating from a digital road map. Furthermore, an object O3 in the form of a traffic light, an object O4 in the form of a stop sign, an object O5 in the form of a pedestrian crossing, and two objects O1, O2 in the form of vehicles are present in the region of the road crossing.

For an automated, in particular highly automated or autonomous driving mode of vehicles, precise recognition of objects O1 to O11 in the environment of the vehicle is necessary. For this purpose, automated vehicles have an environment recording sensor system, for example comprising lidars, radars, cameras, and ultrasound sensors. Respective sensor modalities can be present redundantly. During the environment recording, sensor measurements of the sensor modalities are used individually or in combination. False-negative measurement results, i.e., a failure to recognize real objects O1 to O11 in the environment, and false-positive measurement results, i.e., recognition of false objects O1 to O11, so-called ghost objects, must be avoided in this case.

When recording the environment with a low degree of sensitivity, there is a risk that not all real objects O1 to O11 are detected in the environment, which may result in dangerous situations in the automated driving mode of the vehicle.

When recording the environment with a high degree of sensitivity, on the other hand, there is a risk that ghost objects that are not present in the environment are detected in the environment. This may also result in dangerous situations in the automated driving mode of the vehicle.

To be able to decide whether an object O1 to O11 actually exists, context information about the traffic situation or traffic scene is used in a method for detecting ghost objects in sensor measurements of an environment of a vehicle. As a result, the environment can be initially recorded with a high degree of sensitivity and then ghost objects can be detected in the recorded sensor measurements and removed from the sensor measurements.

A road network that is the basis of the traffic situation and is taken from a digital road map as map context information provides valuable information. The road network is described among other things by the objects O6 to O11 in the form of lane segments.

Other vehicles in the immediate surroundings of the vehicle—in the present case, for example, the objects O1, O2—provide further valuable information. Social context information is generated from relationships between the objects O1, O2.

To achieve the high degree of sensitivity when recording the environment, in the method, all available data from the traffic situation is stored in a graph structure GS depicted in more detail in FIG. 5, the so-called scene graph. Relational information is depicted in this graph structure GS by means of edges E1 to En, which connect nodes K1 to Km.

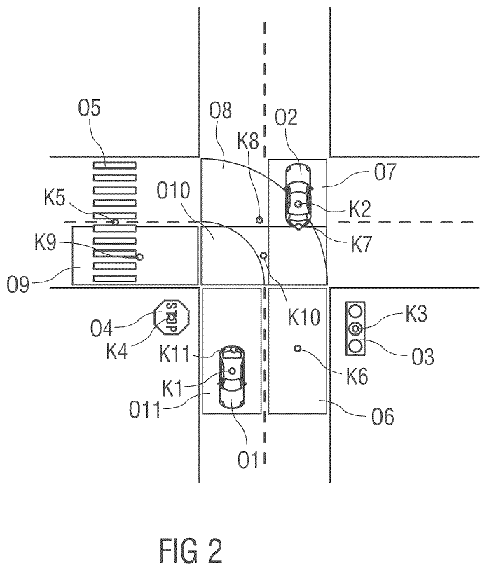

FIG. 2 shows a plan view of the traffic scene according to FIG. 1 with generated nodes K1 to K11 for a possible exemplary embodiment of a graph structure GS.

To generate the graph structure GS, nodes K1 to Km are formed for all available dynamic information DI, static information SI and semantic information SEI, respectively depicted in more detail in FIG. 5.

The static information SI comprises, for example, the objects O6 to O11 in the form of lane segments, the dynamic information DI comprises, for example, the objects O1, O2 in the form of vehicles and the trajectories of the objects, and the semantic information SEI comprises, for example, the object O4 in the form of a stop sign, traffic signal arrangements, for example the object in the form of a traffic light O3, the object O5 in the form of a pedestrian crossing, and other traffic control devices.

In the present case, for example, a node K6 to K11 is assigned to each lane segment (object O6 to O11), a node K4 is assigned to the stop sign (object O4), a node K5 is assigned to the pedestrian crossing (object O5), a node K3 is assigned to the traffic light (object O3), and a node K1, K2 is respectively assigned to the objects O1, O2 in the form of vehicles.

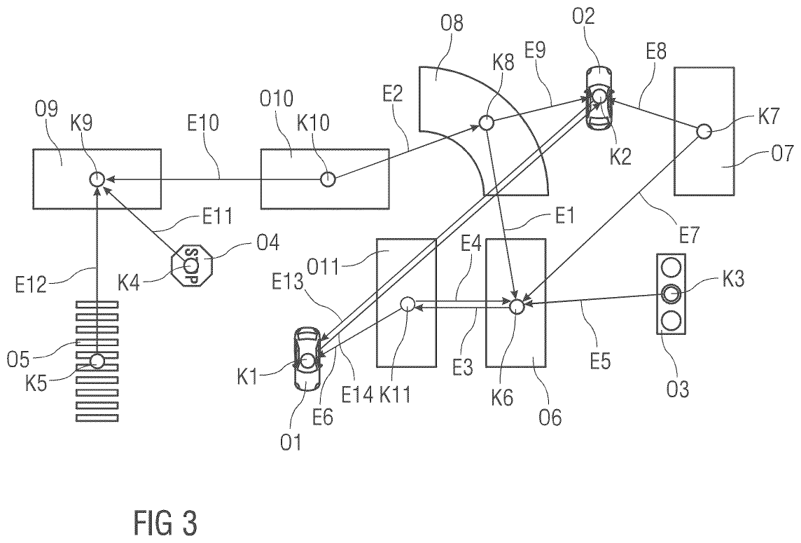

FIG. 3 shows the nodes K1 to K11 according to FIG. 2 and the edges E1 to E14 connecting them for a possible exemplary embodiment of a graph structure GS.

The edges E1 to E14 form relational information RI also depicted in more detail in FIG. 5, i.e., dependencies and relationships between the nodes K6 to K11.

For example, the edge E1 depicts, as relational information RI, that the object O8 (node K8) in the form of a lane segment is connected to the object O6 (node K6) in the form of a lane segment. It is, for example, stored as a relationship-specific attribute that when driving through the road crossing, the object O8 follows the object O6.

For example, the edge E2 depicts, as relational information RI, that the object O10 (node K10) in the form of a lane segment precedes the object O8 (node K8) in the form of a lane segment. It is, for example, stored as a relationship-specific attribute that object O10 is the first predecessor of the object O6.

For example, the edge E3 depicts, as relational information RI, that the object O6 (node K6) in the form of a lane segment and the object O11 (node K11) in the form of a lane segment are connected. It is, for example, stored as a relationship-specific attribute that the object O6 is the right-hand neighbor of the object O11.

For example, the edge E4 depicts, as relational information RI, that the object O11 (node K11) in the form of a lane segment and the object O6 (node K6) in the form of a lane segment are connected. It is, for example, stored as a relationship-specific attribute that the object O11 is the left-hand neighbor of the object O6.

For example, the edge E5 depicts, as relational information RI, that regulatory content of the traffic light (Object O3, node K3) applies to the object O6 (node K6) in the form of a lane segment.

For example, the edge E6 depicts, as relational information RI, that the object O11 (node K11) in the form of a lane segment is located underneath the object O1 (node K1) in the form of a vehicle. It is, for example, stored as a relationship-specific attribute that the lane segment has a certain probability, for example of 1.0, of being located underneath the vehicle.

For example, the edge E7 depicts, as relational information RI, that the object O7 (node K7) in the form of a lane segment and the object O6 (node K6) in the form of a lane segment are connected. It is, for example, stored as a relationship-specific attribute that when driving through the road crossing, the object O7 follows the object O6.

For example, the edge E8 depicts, as relational information RI, that the object O7 (node K7) in the form of a lane segment is located underneath the object O2 (node K2) in the form of a vehicle. It is, for example, stored as a relationship-specific attribute that the lane segment has a certain probability, for example of 0.7, of being located underneath the vehicle.

For example, the edge E9 depicts, as relational information RI, that the object O8 (node K8) in the form of a lane segment is located underneath the object O2 (node K2) in the form of a vehicle. It is, for example, stored as a relationship-specific attribute that the lane segment has a certain probability, for example of 0.3, of being located underneath the vehicle.

For example, the edge E10 depicts, as relational information RI, that the object O10 (node K10) in the form of a lane segment and the object O9 (node K9) in the form of a lane segment are connected. It is, for example, stored as a relationship-specific attribute that the object O10 follows the object O9.

For example, the edge E11 depicts, as relational information RI, that regulatory content of the stop sign (Object O4, node K4) applies to the object O9 (node K9) in the form of a lane segment.

For example, the edge E12 depicts, as relational information RI, that the pedestrian crossing (object O5, node K5) passes over the object O9 (node K9) in the form of a lane segment, i.e., overlays the latter.

For example, the edges E13, E14 depict, as relational information RI, that the objects O1, O2 (nodes K1, K2) in the form of vehicles interact with each other. Relationship-specific attributes are, for example,
geometric relationships between the objects O1, O2, for example a difference in position between the vehicles in meters,
geometric relationships between the objects O1, O2, for example a difference in yaw angles of the vehicles in relation to each other, i.e., a difference in an alignment of the vehicles,
kinematic relationships between the objects O1, O2, for example a difference in speed between the vehicles.

The previously specified objects O1 to O11, the relational information RI and the attributes represent possible examples. The approach described is not limited to the specified object types, relational information RI and attributes, and can be extended in relation to the aforementioned in any way by further possible object types, relational information RI and attributes.

Taking the context information into account, anomalies and patterns can be found in the graph structure GS, which are used to classify ghost objects. The attributes of an object O1 to O11 recorded, for example, with a respective sensor measurement are used as features to classify the objects O1 to O11. These attributes can, for example, take into account a category of the respective object O1 to O11, for example vehicle, traffic sign, pedestrian etc., and/or a type of the respective object O1 to O11. For example, for an object O1 to O11 that is categorized as a vehicle, possible object types are passenger cars, heavy goods vehicles, buses, motorbikes etc. The attributes can also comprise further information describing an object O1 to O11, for example a kinematic state and/or position information.

This means that a respective sensor measurement of an object O1 to O11 to be classified comprises not only the respective object O1 to O11 itself, but also specific attributes of the object O1 to O11 that assist the classification.

As attributes of relationships between the objects O1 to O11,
geometric relationships between objects O1 to O11 and/or
geometric relationships between objects O1 to O11 and positions in their environment and/or
kinematic relationships between dynamic objects O1 to O11 and/or
semantic relationships between objects O1 to O11 and/or
static relationships between the objects O1 to O11 can furthermore be used as features for the classification of the objects O1 to O11.

For example, attributes of the objects O1 to O11 and/or attributes of relationships of the objects O1 to O11 can be used as features for the classification of the objects O1 to O11, the attributes for example comprising
temporal information,
a spacing of the object O1 to O11 from the ego vehicle during a first detection of the object O1 to O11 and/or during first sensor measurements of a measurement series,
a speed of the object O1 to O11 in comparison with surrounding objects O1 to O11,
a position of the object O1 to O11 in comparison with the road network, and/or
an orientation of the object O1 to O11 in comparison with the orientation of a lane segment located underneath it.

This means, for example, that a first sensor measurement can be classified. Several “first” sensor measurements can also be classified, however. There are requirements for the reaction time of automated vehicles to objects O1 to O11 in their environment. If several sensor measurements of the same sensor take place in this time, several “first” sensor measurements can thus also be used for classification. Sensor measurements can thus also be used over time, such that a historical context of an object O1 to O11 can be calculated and thus deliver helpful patterns. This makes it possible, for example, to record behavior of vehicles over time, and to take this into account even before the actual object O1 to O11 is recognized.

In one possible embodiment, it is further provided that in the case of sensor measurements by means of several sensors, i.e., redundant sensors, object hypotheses determined from sensor measurements of individual sensors are taken into account and a detection of ghost objects in sensor measurements carried out by means of at least one further sensor is plausibility or implausibility tested using at least one object hypothesis of at least one sensor measurement of a sensor.

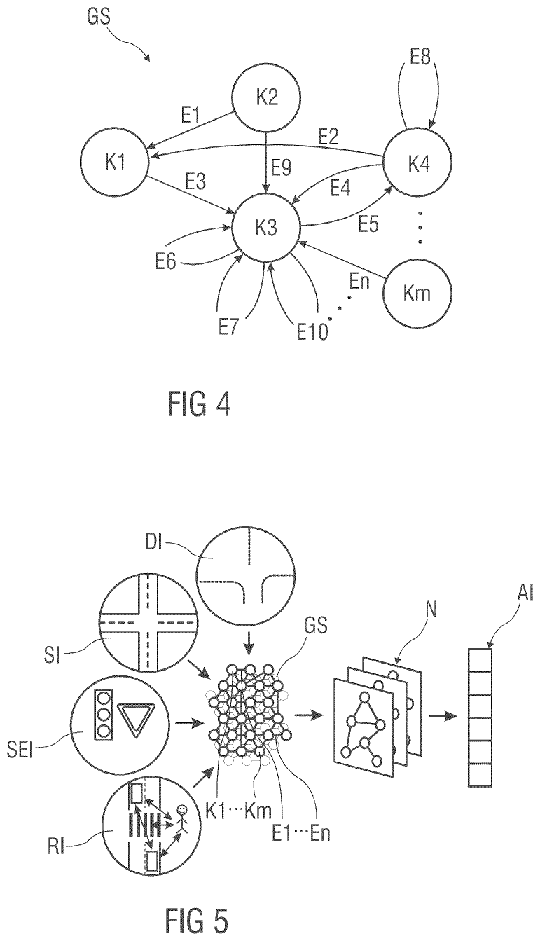

In FIG. 4, a possible exemplary embodiment of a graph structure GS having several nodes K1 to Km and edges E1 to En representing relationships between the nodes K1 to Km is depicted.

Here, a node K1 is, for example, a pedestrian crossing, a node K2 is a traffic signal arrangement, a node K3 is a lane, a node K4 is a traffic participant, and a node Km is a stop sign.

Between the nodes K1 to Km, edges E1 to En are formed, which represent relationships between the nodes K1 to Km, i.e., relational information RI.

For example, the edge E1 depicts, as relational information RI, that the traffic signal arrangement (node K2) indicates or signals the pedestrian crossing (node K1).

For example, the edge E2 depicts, as relational information RI, that the traffic participant (node K4) is crossing the pedestrian crossing (node K1).

For example, the edge E3 depicts, as relational information RI, that the pedestrian crossing (node K1) passes over the lane (node K3) or overlays the latter.

For example, the edge E4 depicts, as relational information RI, that the traffic participant (node K4) is crossing the pedestrian crossing (node K3).

For example, the edge E5 depicts, as relational information RI, that the lane (node K3) is located underneath the traffic participant (node K4).

For example, the edge E6 depicts, as relational information RI, that the lane (node K3) is in conflict with another node K5 to Km-1 (not depicted in more detail) or the node K5 to Km-1 is in conflict with the lane.

For example, the edge E7 depicts, as relational information RI, that the lane (node K3) is connected to another node K5 to Km-1 (not depicted in more detail) or the node K5 to Km-1 is connected to the lane.

For example, the edge E8 depicts, as relational information RI, that the traffic participant (node K4) interacts with another node K5 to Km-1 (not depicted in more detail).

For example, the edge E9 depicts, as relational information RI, that regulatory content of the traffic signal arrangement (node K2) applies to the lane (node K3), i.e., controls objects O1 to O11 located in the lane.

For example, the edge E10 depicts, as relational information RI, that the lane (node K3) precedes another node K5 to Km-1 (not depicted in more detail) or the node K5 to Km-1 precedes the lane.

For example, the edge En depicts, as relational information RI, that regulatory content of the stop sign (node Km) applies to the lane (node K3), i.e., stops objects O1 to O11 located in the lane.

The depicted graph structure GS represents only one possible exemplary embodiment of such a graph structure, and can be flexibly expanded or limited depending on requirements and an environment situation.

FIG. 5 shows a configuration of a graph structure GS and the processing of information present in the graph structure GS with a graph-based artificial neural network N.

In one possible exemplary embodiment of the method of detecting ghost objects in sensor measurements of an environment of a vehicle, the ghost objects are classified on the basis of learning.

The static information SI, the dynamic information DI, the semantic information SEI and the relational information RI are transferred into the graph structure GS as input information about the traffic situation.

A form of a learning-based method, in particular the graph-based artificial neural network N, is then used, wherein output information AI gives information about the classification of individual objects O1 to O11 as a ghost object and actually existing objects O1 to O11.

Although the invention has been illustrated and described in detail by way of preferred embodiments, the invention is not limited by the examples disclosed, and other variations can be derived from these by the person skilled in the art without leaving the scope of the invention. It is therefore clear that there is a plurality of possible variations. It is also clear that embodiments stated by way of example are only really examples that are not to be seen as limiting the scope, application possibilities or configuration of the invention in any way. In fact, the preceding description and the description of the figures enable the person skilled in the art to implement the exemplary embodiments in concrete manner, wherein, with the knowledge of the disclosed inventive concept, the person skilled in the art is able to undertake various changes, for example, with regard to the functioning or arrangement of individual elements stated in an exemplary embodiment without leaving the scope of the invention, which is defined by the claims and their legal equivalents, such as further explanations in the description.

1-5. (canceled)

6. A method for detecting ghost objects in sensor measurements of an environment of a vehicle, the method comprising:
obtaining map context information from a digital road map;
detecting objects having associated attributes in the environment of the vehicle;
generating social context information about the detected objects in relation to one another, wherein the social context information is generated from relationships between the detected objects located in the vicinity of the vehicle;
storing all available data about a traffic situation involving the vehicle and the detected objects in a graph structure comprising nodes and edges, wherein relational information is depicted in the graph structure by the edges;
searching for anomalies and patterns in features of the graph structure while taking the map context information and the social context information into account; and
classifying one or more of the detected objects as ghost objects using detected anomalies and patterns in the graph structure,
wherein object hypotheses from sensor measurements of several individual sensors are taken into account and a detection of ghost objects in further sensor measurements by at least one further sensor is plausibility or implausibility tested using at least one object hypothesis of at least one sensor measurement of the sensor measurements of the individual sensors.

7. The method of claim 6, wherein the features of the graph structure are
geometric relationships between the detected objects,
geometric relationships between the detected objects and locations of the detected objects in the environment,
kinematic relationships between the detected objects that are dynamic objects,
semantic relationships between the detected objects, or
static relationships between the detected objects.

8. The method of claim 6, wherein the features of the graph structure are
temporal information,
a spacing of the vehicle from at least one of the detected objects in the environment during a first detection of the detected object or during first sensor measurements of a measurement series,
a speed of at least one of the detected objects compared with further surrounding objects,
a position of at least one of the detected objects compared with a road network determined from the map context information, or
an orientation of at least one of the detected objects compared with an orientation of a lane located under the at least one of the detected objects.

9. The method of claim 6, wherein the classification is performed using learning by a graph-based artificial neural network.
